(19) United States
(12) Patent Application Publication
(10) Pub. No.: US 2004/0246104 A1
(43) Pub. Date: Dec. 9, 2004

(54) Method for monitoring goods

(76) Inventors: Rolf Baechtiger, Oberwil-Lieli (SE); Charles Zehnder, Binningen (SE)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/677,380

(22) Filed: Oct. 3, 2003

(30) Foreign Application Priority Data
Oct. 4, 2002 (EP) 02 022 420.0

(51) Int. Cl. G08B 21/00; G08C 19/22

(52) U.S. Cl. 340/10.41; 340/540; 340/10.1; 340/870.07; 340/568.2

(57) ABSTRACT

To monitor goods and/or containers a method and a system are proposed that comprises the following components. Each good or container is allocated a transponder on which influence variables on the good or on the container are recorded by means of a sensor means. The transponders are wirelessly connected to each other, e.g. as an ad-hoc network. One of the transponders transmits all of the recorded influence variables to an allocated communication unit. In this way, a system is provided that automatically, and without manual intervention, provides very early detection of impermissible effects on the goods to be stored or transported. In this way, for example, a re-ordering can be activated before the impaired goods are delivered to the intended recipient.

### CROSS REFERENCE TO RELATED APPLICATIONS

The present information claims priority to European patent application 02022420.0, filed on Oct. 4, 2002.

### BACKGROUND OF THE INVENTION

The present invention relates to a method for monitoring goods and also to a monitoring system for implementing the aforementioned method. The present invention is concerned with the field of monitoring and tracking of goods to be transported by transport means or also of goods within an area.

In order to provide information to recipients of the probable arrival time of goods transported in contains, web-based information systems are known whereby a potential recipient can inquire about the progress of the transport of his goods. These systems are based, for trucks for example, on a location determined by means of the global positioning system GPS. In this case, an allocation of the contract or job number to the relevant truck is stored in a database of a transport company. The allocation itself can, for example, be made by means of a barcode reader. The truck driver reads a barcode placed on a container by means of a device. This information is transmitted to the named central database by means of a communication and locating unit on the truck. In this case, the barcode is the code of a consignment note.

For acquiring the data in the manner of the aforementioned system, a method is proposed in document DE 199 11 302 A1 (Creutzmann, Jochen, D E-Hamburg) whereby the required data is entered in a storage device on the vehicle when loading and unloading. Transponders are provided for identification of the goods or containers(s). By means of updated location information for the vehicle, it is also possible to determine a deviation from the transport route and if necessary to trigger a message to the associated transport company by means of a transmitting device on the relevant vehicle. If the cargo compartment is opened at an inappropriate time, impairment of the aforementioned kind can also occur. Therefore it is possible to direct intervention forces to the location of the relevant vehicle. The disadvantage with this is that the data acquisition must necessarily take place during loading and unloading of the goods.

Document DE 196 28 801 A1 (Daimler-Benz Aerospace AG) discloses a computer-aided goods management system whereby stationary or mobile reading/writing equipment connected to transponders on the vehicles is arranged along the planned route, in order to exchange data. The onward journey of the relevant transport vehicle is permitted or prevented depending on the results of the check of the exchanged data.

For monitoring the goods to be transported, it is important that the receiver knows not only the exact location and the probable arrival time but also, where necessary, the circumstances that would pose a danger to the goods to be transported. This is particularly important for perishable products. It is not sufficient in this case to simply determine during unloading by means of a logbook or log file that, for example, the transported ice cream was temporarily exposed to a temperature greater than −5° C. and when the normal temperature of −24° C. was restored it crystallized and therefore could no longer be sold. This information should already be made accessible in advance to the recipient and/or sender of the ice cream. In this way, a second delivery could be activated without the recipient having to be told.

### SUMMARY OF THE INVENTION

An object of the invention is therefore to provide a monitoring system for goods that, without manual procedures, monitors a number of goods or goods containers with respect to the instantaneous location and the relevant influence factors, so that intervention based on the corresponding data is possible before delivery to th destination.

By means of the process steps, in accordance with which:

A influence variables on a good in each allocated transponder is recorded with a connected sensor means,

B the transponder transmits the recorded influence variables to each other via their transmitting/receiving modules, and

C one of the transponders transmits, via its transmitting/receiving module of the communication unit allowed to the transport means, all of the influence variables recorded by the transponders.

A method is provided that autonomously and automatically records influence variables on goods and makes this information accessible to a communication unit for evaluation. The means required for performing the method can be allocated in a simple manner to the goods to be transported or stored thanks to radio communication of the transponders with each other.

By means of a communication link between the communication unit and a remote center, the recorded influence variables from a number of transport means can be monitored and measures for intervention, correction or help can be activated very early in the event of deviations from the permissible values of the influence variables being detected. In this way, further damage to the transported goods can be avoided in individual cases.

The sensor means for recording the influence variables can also be allowed to a container holding the goods, without this requiring the method in accordance with the invention to be modified. In particular, mixed operation is possible on one transport means with some sensors being allocated to containers and others directly to the goods.

The number of transponders on a transport means from an ad-hoc network. This means that when loading a transport means with containers or goods there is absolutely no need to take account of their spatial arrangement because these transponders autonomously organize communication between each other.

Messages output by the communication unit to the transponder at the start of a transport are determined on the basis of acknowledge messages of the particular transponder that transmits all of the influence variables recorded by the transponders to the communication unit. This means that when loading no account needs to be taken of the stacking of containers or goods or of the allocation of transponders to containers or goods.

### BRIEF DESCRIPTION OF THE SEVERAL VIEWS OF THE DRAWINGS

The novel features believed characteristic of the invention are set out in the claims below, The invention itself however, as well as other features and advantages thereof, are best understood by reference to the detailed description, which follows, when read in conjunction with the accompanying drawing, wherein:

FIG. 1 depicts an arrangement on a ship of the compounds of the system in accordance with the invention;

FIG. 2 depicts an arrangement on a train of the components of the system in accordance with the invention;

FIG. 3a depicts an arrangement of a transponder on a container;

FIG. 3b depicts a block diagram of a transponder;

FIG. 4 depicts a block diagram of the functional components of a transmitting/receiving unit on a means of locomotion; and

FIG. 5 depicts a topological arrangement of transponders.

### DETAILED DESCRIPTION OF THE INVENTION

FIG. 1 shows a ship with a ship's hold 8 as a transport means 2, that holds containers 5 in a free and unordered manner, in which the goods to be transported 3 are contained. A communication unit 4 is fitted, preferably on the deck of the ship. In this example of an embodiment, each container 5 is provided with a transponder 1. For reasons of clarity this is only partially shown in FIG. 1. Each of these transponders 1 is connected to at least one sensor means 20. Influence variables detected by the sensor means 20 are recorded in the associated transponder 1. One or more of the following influence variables can be recorded by sensor means 20.

Temperature within container 5 or outside container 5.

Air humidity in container 5.

Acceleration, e.g. impact, shock or vibration.

Electromagnetic field on container 5.

Ionizing radiation.

Chemical composition of the ambient air.

Opening of the container 5 or of the good 1 by means of a contact

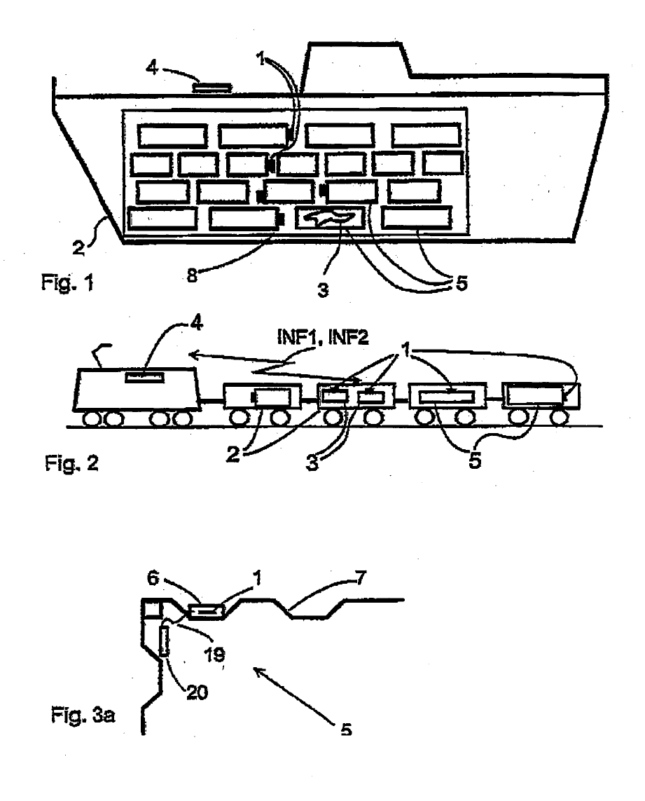

A second arrangement of goods 3 transported in containers 5 is shown in FIG. 2 as a freight train. In particular, the transponders 1 do not need to be attached to a container 5, but can instead be mounted directly on one of the goods 3 to be transported, as is shown on the second goods wagon in FIG. 2.

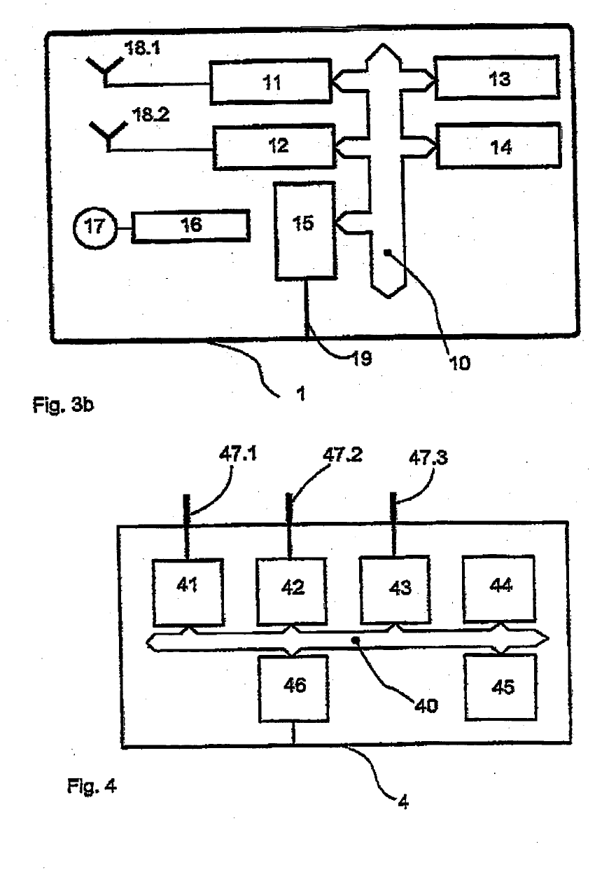

FIG. 3a shows an example of the mounting of a transponder 1 on a container 5. The transponder 1 is mounted on the corrugated outer wall 7 of a container 5 by means of a supporting element 6. The preferred form of a transponder 1 is as an “electronic ticket” such as is disclosed in document WO 01/20557 A1 (Siemens Transit Telematic systems AG). A transponder 1 of this kind is typically the size of a credit card, The supporting element 6 can preferably be a plastic compound or a fabric pocket. If it is a fabric pocket, his is preferably affixed to a predetermined point of a container 5 by means of a hook and eye closure. The fabric pocket itself can also be provided with a closure in order to hold a specific transponder within it in a simple manner. The sealing can also be based on a hook and eye closure. Thanks to the small size of the transponder, 1 including the supporting element 6 it can be attached in a “valley” of the corrugated surface of the container 5. This minimizes the danger of shearing off or pulling off, e.g. during loading. A connection line can be pulled through to a sensor means 20 within the container 5 through an opening in the outer wall 7, By means of this sensor means 20, the air temperature inside the container 5, for example, can be recorded. To record an electromagnetic field, an ionizing radiation or acceleration such as vibration, impact or sock the sensor means can also be mounted outside on the outer wall 7 of the container 5. The following are further examples of influence variables to be recorded wit a containers 5:

The chemical composition of the ambient air, sum as the amount of nitrogen N₂ or the presence of exhaust gases. Instead of the aforementioned hook and eye closure, the attachment of the transponder 1 can be such that the transponder 1 is secured by a wire loop that carries a current at the transponder end. The wire loop is passed through the interface module 15, which is described in more detail below. This enables unauthorized removal of a transponder 1 from a container 5 or from a good 3 to be determined and an alarm for the attention of intervention forces to be triggered if necessary.

FIG. 3b is a block diagram of a transponder 1 showing the following components.

First receiving module 11 and second transmitting/receiving module 12 with allocated antennas 181 and 182.

Processor module 13 and memory module 14.

Interface module 15 to which at least one sensor means is connection via the connecting link 19.

Power supply module 16 with battery 17 (the electrical connections are not shown).

The aforementioned modules 11, 12, 13, 14 and 15 are connected to each other via a bus system 10.

There are various ways in which communication with a transponder 1 can be realized. In this example, these are based on the method disclosed in document WO 01/20557 A1. By means of the fast receiving module 11, the transponders 1 are wakened from sleep by a signal, e.g a 7.68 MHz signal. At a higher layer this signal contains a message with various information fields. These also contain information on the basis of which the second transmitting/receiving module 12 is switched to an intermittent mode, with this second transmitting/receiving module 12 preferably being operated at a substantially higher frequency, e.g. in the 868 MHz range. From the point of view of a transponder 1, one frequency each is to be provided for the outgoing and incoming communication link, e,g. 868.0 MHz and 868.5 MHz. It is also possible to have a semi-duplex method on one single frequency. As an alternative to the aforementioned method, the wake-up can be automatically achieved by a device during the attachment of the ticket or transponder 1 to a container 5 or during the loading of ship 2. To do this, all that is required for the communication unit 4 or its antenna 473 to be positioned close to the loading opening for the ship's hold 8 and switched to the “wake-up” mode. The transponder 1 has, in accordance with document WO 01/20557 A1, a high degree of autonomy. With this application for recording influence variables, the interval for the bi-directional communication can be set to a longer grid in a range of some minutes or even more. This enables the autonomy to be further increased. The transponders 1 each have their own identity. If transponder 1 is allocated to container 5 or transport good 1, this is to be recorded for subsequent evaluation and monitoring. This can be carried out by using a mobile writing/reading device, the data of which is later transmitted to a center. By means of this device, a transponder can also be wakened at a frequency of, e.g. 7.68 MHz by means of the method described in WO 01/20557 A1, or it is also possible to transmit the data in the intermittent mode to the relevant transponder 1 by means of an electrical connection.

The topological arrangement of a number of transponders 1 in a ship's hold 8 or on a railway train 2 (see FIG. 2) is shown in the block diagram in FIG. 5. FIG. 2 with railway wagons connected in line suggests a bus structure. This is not so because the transponders 1 cannot detect any neighboring structure. Therefore the communication connections can be, or are, as a rule established form one transponder 1 to several other transponders 1. In a topology of this kind, these transponders form an ad-hoc network. The operation of ad-hoc networks is, for example, given in document DE 100 62 303 A1 (7 layers AG, D E-Rattingen). In FIG. 5 it is assumed that transponder 9 functions as a master transponder 9. A bi-directional communication with the communication unit 4 allocated to the transport means 2 takes place from this transponder 9. As illustrated in FIG. 5, a mutual transmission of the influence variables recorded in the individual transponders 1 takes place. A INF1 data structure, an example of which is shown in the following table 1, is used for this purpose. Instead of the term data structure, the term message structure is also used in this context.

TABLE 1
INF1 information unit

| Information field | Meaning |
|---|---|
| ADDRESS1 | Address of the transmitting transponder 1. |
| ADDRESS2 | Address of transponder 1 on which the |
| | ENVIRONMENT_VALUES |
| | were recorded. |
| DATETIME1 | Date and time. Time stamp of the |
| | transmission to the receiving |
| | transponder 1. |
| COMMAND | Commands to the receiving transponder 1. |
| ENVIRONMENT_VALUES | Recorded influence variables. |
| | This entry can also be omitted |
| | depending on the entry in |
| | the COMMAND field. |
| DATETIME2 | Date and time. Time stamp of the |
| | recording of the |
| | ENVIRONMENT_VALUES field. |
| : | : |

Both the received and also the influence variables recorded on the relevant transponder 1 are stored in a table in each transponder 1, with the FILE data type being preferably used. This ad-hoc network is the basis whereby one of the transponders 1 succeeds in establishing a bi-directional communication link with the communication unit 4 allocated to the transport means 2. This transponder is shown in FIG. 5 by the reference designator 9 and is called a master transponder.

The “master transponder” function is preferably allocated dynamically. A special message can be transmitted from communication unit 4 for this purpose. The transponder 1 receiving this message acknowledges receipt of this message. Communication unit 4 analyses which of the aforementioned transponders has the best reception and transmission conditions. For this purpose, the reception level and its time characteristic (“shape” of the received signal) can, for example be analyzed using reflections. The basic requirement for this is that a connection on layer 1 (within the meaning of the OSI model) is always ensured. In the aforementioned manner, the communication unit 4 can allocate the “master transponder” 9 function to the selected transponder 1 by transmitting a message to it.

Following successful reception of the information units INF1 with the recorded influence variables transmitted from the master transponder 9 to communication unit 4, communication unit 4 provides an acknowledgement. This deletes the influence variables recorded in the aforementioned table or file. Master transponder 9 then transmits a further information unit IFN2 with a structure comparable to that of INF1. An indication to delete the relevant information unit in the receiving transponder 1 is in this case contained in the COMMAND field. A distinction can now be made between two cases, as follows.

The relevant information unit INF1 originates from the receiving transponder. The procedure is ended.

The relevant information unit INF1 originates form a different transponder than the receiving transponder. A transmission of a further information unit INF2 then takes place. The address of the receiving transponder 1 is known at the same time, refer to the ADDRESS1 field.

If a transponder 1 receives an information unit INF2 not meant for it, it is preferably rejected.

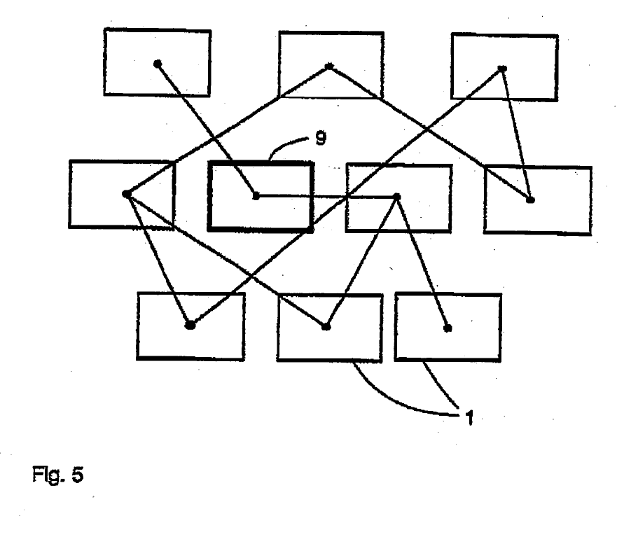

To explain the further processing of the influence variables transmitted from the master transponder 9, the functional units of a communication unit 4 are first explained using FIG. 4.

FIG. 4 shows a communication unit that in this construction contains the following.

Sending/transmitting unit 42 for communication with a remote center.

Sending/transmitting unit 43 for communication with the transponders and the master transponder 9.

Locating unit 41, e.g. a GPS receiver.

Processor unit 44 and memory unit 45.

Antennas 471, 472 and 473 for locating units 41 and for transmitting/receiving units 42 and 43.

Power supply unit 46.

Bus system 40 for connection of the aforementioned units.

The influence variables, including at least one time stamp, communicated via the master transponder 9 to the communication unit 4, are stored in the memory unit 45, e.g. as a FILE data type. To determine and assess the reliability of the recorded influence variables using the method in accordance with the invention, a communication link is established between the communication unit 4 and a remote center. The transmitter/receiving unit 43, which for example is part of the trunk radio system such as TETRA or TETRAPOL or a cellular mobile communication system such a GSM is used for this purpose. When the recorded influence variables are transmitted they are advantageously provided with location information. The location information can be taken form the locating unit 41. Depending on the type of transported goods 3, it can also be provided that the location information is stored relative to a time grid, e.g. at intervals of 30 s. Because the recorded influence variables are also provided with a time stamp, in this way the particular relevant location information can be allocated at the center during transmission. In this way, an impermissible effect can be reconstructed if necessary using post-processing. This is significant, particularly for transport by truck. Be means of post-processing, any missing recording can also be detected, which for example could occur due to a parallel run of two freight trains.

The aforementioned antennas 411, 472 and 473 need not be connected directly to communication unit 4, but instead can be advantageously arranged remotely, so that optimum transmitting/receiving conditions can be achieved. If necessary, there can also be several antenna 473 in or at a ship's hold.

The invention is not, for example, limited to the aforementioned embodiment.

It is also possible to use a wireless network already in a transport means as a transport medium, e.g. a private wireless LAN or a public wireless LAN.

The invention can also be used in a warehouse 2 or a storage area 2, where a number of goods have to be monitored with regard to the effects of environmental influences and their presence. The specification of the master transponder 9 function can in this case take place within a fixed time grid. This function then has to be re-specified if the relevant good 3 was moved out of the storage area. During this process, either transponder 9 can be left on good 3 or deliberately deactivated by means of a manual intervention using the mentioned read/write device.

What is claimed is:

1. Method for monitoring goods with each good being allocated a transponder having a transmitting/receiving module and a communication unit being provided for one of the transport means, that serves a wireless bi-directional communication with transponders, characterized by the following procedural steps:
A Influence variables on a good are recorded in each allocated transponder with a connected sensor means;
B The transponders communicates the recorded influence variables to each other through their transmitting/receiving modules; and
C One of the transponders transmits all of the influence variables recorded by the transponders to an allocated communication unit through its transmitting/receiving module.

2. Method in accordance with claim 1,
characterized in that,
individual goods are located in containers and a transponder allocated to a container and in procedural step A the influence variables on the container and/or on the goods contained in container are recorded.

3. Method in accordance with claim 1,
characterized in that,
in procedural step B the transponders form an ad-hoc network.

4. Method in accordance with one of claim 1, characterized in that for the procedural step C the transponder that communicates to the communication unit all of the influence variables recorded by the transponders is determined form messages transmitted from the communication unit to the transponders on the basis of the acknowledgement messages generated by these.

5. Methods in accordance with claim 1,
characterized in that by a procedural step D following procedural step C, according to which
the allocated communication unit transmits all of the influence variables communicated from one transponder to a remote center.

6. Method in accordance with one of claim 1, characterized in that,
the current time is additionally recorded in procedural step A.

7. Method in accordance with claim 5, characterized in that,
in procedure D location information originating form a locating unit is additionally communicated.

8. Method in accordance with claim 6, characterized in that,
the particular locating information is stored in time intervals in the communication unit and in that in procedural step D the relevant locating information is communicated on the basis of the time allocation during the transmission of the complete influence variables.

9. Method in accordance with one of claim 1,
characterized in that,
in procedure step C, after successful transmission of all of the recorded influence variables one transponder sends a message to the other transponders on the basis of which the influence variables still recorded in the transponders are deleted.

10. Method in accordance with one of claim 1,
characterized in that,
in procedure step A, by means of sensor means one or more of the following influence variables is recorded as required.
Temperature
Air humidity
Acceleration
Electromagnetic field
Ionizing radiation
Chemical composition of the ambient air
Opening of the container of the good (1)
Disconnection of an electrical connection during an attempted or successful removal of a from the container or good.
